(19) United States
(12) Patent Application Publication
(10) Pub. No.: US 2020/0132219 A1
(43) Pub. Date: Apr. 30, 2020

(54) Smart Valve Position Sensor

(71) Applicant: Norriseal-Wellmark, Inc., Houston, TX (US)

(72) Inventors: Zachary J. Thompson, Houston, TX (US); Jeffrey S. Case, Houston, TX (US); Michael Easton, Oklahoma City, OK (US); Daniel D. Sierra, Houston, TX (US)

(21) Appl. No.: 16/510,076

(22) Filed: Jul. 12, 2019

Related U.S. Application Data
(60) Provisional application No. 62/753,514, filed on Oct. 31, 2018.

(51) Int. Cl. F16K 37/00; F16K 31/126; G01S 17/10

(52) U.S. Cl. CPC F16K 37/0058; G01S 17/10; F16K 31/1262

(57) ABSTRACT

A position sensor unit comprising a sensor housing, an optical time-of-flight sensor, and an electronic control unit is presented. The sensor housing includes an optical port such that an optically transmissive seal engaged within the optical port is operable to pass an optical pulse from within the sensor housing to be transmitted to a diaphragm within a pneumatic actuator wellhead and valve assembly, and also, pass a reflected optical pulse from the diaphragm back into the sensor housing. The optical time-of-flight sensor is operable to measure a round-trip propagation time of one or more optical pulses transmitted by the optical-time-of-flight sensor to the diaphragm and reflected back from the diaphragm in order to determine the displacement of the diaphragm. The electronic control unit controls the optical-time-of-flight sensor and provides detected measurements to an external monitoring device.

### CROSS-REFERENCE TO RELATED APPLICATION

This application claims the benefit of U.S. Provisional Application No. 62/753,514, filed Oct. 31, 2018. The contents of the above application are hereby incorporated in its entirety by reference.

### TECHNICAL FIELD

The present disclosure generally relates to position sensors, and in particular, to a position sensor unit configured for use in a pneumatically actuated valve.

### BACKGROUND

Flow control mechanisms such as valves are often placed within wellhead assemblies in order to regulate fluid or gas flow. Generally, valves accomplish this by being controlled to wholly or partially obstruct the wellheads, flowlines, headers, or some other oil/gas pipeline system. A frequently used valve for such applications is a valve pneumatically controlled by an actuator. The actuator controls the gate-valve-based on pneumatic pressure that displaces a diaphragm within it. The diaphragm displacement causes an actuator rod to move up or down depending on the amount of pneumatic pressure present in a pressurized chamber of the actuator. This up-and-down movement of the actuator rod causes the valve to respectively open or close.

Currently, existing wellheads that employ pneumatic valve actuation often use a mechanical indicator to visually determine the position of the valve based on the position of the diaphragm within the actuator. Such solutions not only require on-site observation of the position of the diaphragm using the mechanical indicator, but also lack the capacity to finely resolve and provide precise diaphragm displacement measurements. Additionally, the mechanical indicators in such systems provide faulty diaphragm position measurements due to equipment wear and tear, since such systems are generally not adapted to account for the aging of flow-control components coupled to the wellhead. Moreover, these solutions usually lack smart technology for accurately capturing valve position data and digitally processing this data for informative and for control purposes.

### SUMMARY

According to one aspect of the subject matter described in this disclosure, a position sensor unit for measuring diaphragm displacement in a pneumatic actuator wellhead and valve assembly is presented. The pneumatic actuator and wellhead valve assembly comprises an actuator capturing a pneumatically controlled diaphragm that drives an actuator rod. The actuator rod translates with a displacement of the pneumatically controlled diaphragm and is operable to mechanically actuate a valve to controllably pass gases or liquids according to one of an opening and a closing of the valve. The position sensor unit comprises a sensor housing including an optical port for allowing an optical pulse from within the sensor housing to be transmitted to the pneumatically controlled diaphragm. The optical port also allows the sensor housing to receive a reflected optical pulse from the pneumatically controlled diaphragm back into the sensor housing. The position sensor unit also comprises an optically transmissive seal engaged within the optical port. The optically transmissive seal is operable to pass the optical pulse from within the sensor housing to be transmitted to the pneumatically controlled diaphragm, and also, pass the reflected optical pulse from the pneumatically controlled diaphragm back into the sensor housing.

Additionally, the position sensor unit comprises an optical time-of-flight sensor comprising a light source and a light detector. The optical time-of-flight sensor is operable to measure a distance to the pneumatically controlled diaphragm and thereby determine the displacement of the pneumatically controlled diaphragm. The light source comprised in the optical time-of-flight sensor is operable to send one or more optical pulses to the pneumatically controlled diaphragm while the light detector comprised in the optical time-of-flight sensor is operable to detect reflected optical pulses from the pneumatically controlled diaphragm. The optical-time-of-flight sensor is operable to measure a round-trip propagation time of the one or more optical pulses in order to determine the displacement of the pneumatically controlled diaphragm. The position sensor unit further comprises an electronic control unit in electrical communication with the optical time-of-flight sensor. The electronic control unit is operable to control the optical-time-of-flight sensor and to provide detected measurements to an external monitoring device.

These and other implementations may each optionally include one or more of the following features. The electronic control unit further comprises a wireless transceiver for wirelessly transmitting the detected measurements to the external monitoring device. The optical port is configured within a threaded coupling to be mounted to the actuator capturing the pneumatically controlled diaphragm. The position sensor unit further comprises a modular power that supplies power to the optical time-of-flight sensor and to the electronic control unit. Also, the external monitoring device comprises a cloud-based computing resource that analyzes the detected measurements. Additionally, the cloud-based computing resource can analyze the detected measurements by comparing the detected measurements to baseline measurements in order to determine an operating state associated with the valve. The operating state associated with the valve can indicate that the valve is malfunctioning. In some implementations, the position sensor unit is coupled to one or more indicators that can indicate at least an operating state of the valve based on an alert received by the position sensor unit from the external monitoring device. In some embodiments, the one or more indicators provide a visual indication of a malfunction associated with the valve. Further, the detected measurements can be used to determine a pressure within a pressurized chamber of the actuator.

The disclosed embodiments provide a position sensor unit that combines digital detection of diaphragm displacement with connectivity to analytics devices to more accurately determine whether the valve is operating as configured. Additionally, the disclosed position sensor unit can coordinate with other sensors either integrated into its configuration, or external to the position sensor unit to validate valve position data, and also perform other sensing and control functionality on the valve. Furthermore, the disclosed position sensor unit allows stakeholders to be updated through the sensor unit's connectivity with other external devices without needing any stakeholder to be physically present on-site to manually determine the valve position.

### BRIEF DESCRIPTION OF THE DRAWINGS

The disclosure is illustrated by way of example, and not by way of limitation in the figures of the accompanying drawings in which like reference numerals are used to refer to similar elements. It is emphasized that various features may not be drawn to scale and the dimensions of various features may be arbitrarily increased or reduced for clarity of discussion.

FIG. 1A shows an example position sensor unit mounted on a pneumatic actuator and wellhead valve assembly.

FIG. 1B shows a zoomed illustration of the cross-sectional view of FIG. 1A.

FIG. 2 shows a cross-sectional view of the position sensor unit of FIG. 1A, according to one embodiment.

FIG. 3 depicts a zoomed cross-sectional view of the port of the position sensor unit of FIG. 2.

FIG. 4 depicts a zoomed illustration of a perspective view of the port of the position sensor of FIG. 2.

FIG. 5 shows an adapter-enabled embodiment of the position sensor unit of FIG. 1A.

FIG. 6 shows an example layout of the electronic control unit of the position sensor unit of FIG. 1A.

FIG. 7 shows an example system for communicatively coupling the position sensor unit of FIG. 1A to one or more monitoring devices.

### DETAILED DESCRIPTION

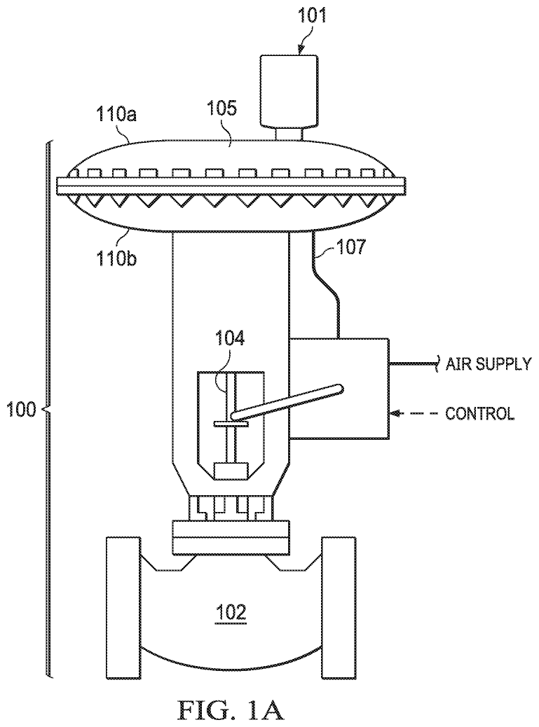

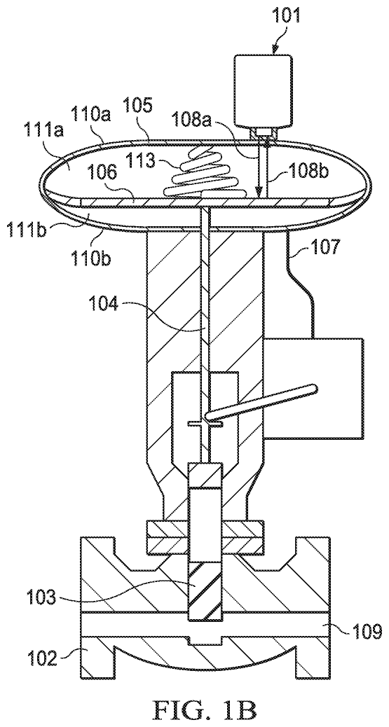

FIG. 1A illustrates a pneumatic actuator and wellhead valve assembly 100 that employs a position sensor unit 101. The lower portion of the assembly 100 includes a valve 102 designed to be normally closed in the event of a system failure so as to stop the flow of production fluid. The upper portion of the pneumatic actuator and wellhead valve assembly 100 includes an actuator 105 that captures a pneumatically controlled diaphragm to drive an actuator rod 104. In an exemplary embodiment, the valve 102 is controlled through the actuator rod 104 which moves a valve plug 103 within the valve 102 up or down under control of the actuator 105 which contains a pneumatically controlled diaphragm 106 that actually effects the actuator rod movement (see FIG. 1B). More specifically, the actuator rod 104 translates with a displacement of the pneumatically controlled diaphragm 106 and is operable to mechanically actuate the valve 102 to controllably pass gases or liquids according to one of an opening and a closing of the valve plug 103.

The pneumatically controlled diaphragm 106 associated with the actuator 105 is operable through a pressurized air control line 107 to be translated upwardly under air pressure from the air control line 107. This in turn translates the actuator rod 104 upwardly. The movement of the actuator rod 104 upwardly is operable to open the valve 102 and allow production fluid to pass through the oil or gas line 109. Further illustrated in the cross-sectional view of FIG. 1B is a position sensor unit 101 positioned at an upper portion 110a of the actuator 105. The upper portion 110a of the actuator 105 contains an unpressurized chamber 111a of the actuator 105 and is opposite to a lower portion 110b of the actuator 105. The lower portion 110b contains a pressurized chamber 111b of the actuator 105, where the pressure in the pressurized chamber 111b is created by the pressurized air coming in through the air control line 107. It is this pressure of the pressurized chamber 111b that displaces the diaphragm 106 up and down to effect the actuator rod 104 movements. The position sensor unit 101 of the presently disclosed embodiments operates, as further disclosed below in this specification, to detect the distance of the diaphragm 106 relative to the position sensor unit 101 and accordingly determine whether the valve 102 is open or closed. Although in the presently illustrated embodiment, the pressurized chamber 111b is illustrated within the lower portion 110b of the actuator 105, it can be appreciated that the pressurized chamber 111b may be within the upper portion 110a of the actuator 105 with the air control line 107 being correspondingly attached to the upper portion 110a. Correspondingly, the position sensor unit 101 can be placed at the lower portion 110b of the actuator 105 without departing from the principles discussed in this disclosure. In any case as long as the position sensor unit 101 is placed in a position on the actuator 105 to detect upward or downward movement of the diaphragm 106, the amount by which the diaphragm 106 is displaced can be measured using the position sensor unit 101.

More specifically, the described embodiments measure the relative distance between the diaphragm 106 and the position sensor unit 101 based on the amount of time it takes an optical pulse to be transmitted 108a to the pneumatically controlled diaphragm 106 and reflected 108b back to the optical-time-of-flight sensor associated with the position sensor unit 101 as seen in FIG. 1B. Additionally, the spring 113 may be operable to restrict or otherwise control the diaphragm displacement and/or actuator rod motion. It should be appreciated that the spring 113 can be positioned on either side of the diaphragm 106, or coupled to the actuator rod 104 without departing from the principles described in this disclosure.

Further, it is appreciated that the position sensor unit 101 may be located or mated to the actuator 105 on the pressurized chamber 111b, and may be operable to use time-of-flight measurements to measure diaphragm displacement at the side of the pressurized chamber 111b of the actuator 105. In certain embodiments, the position sensor unit 101 might be provided in an integrated assembly, or in association with a pressure sensor such that a common housing and/or electronics could be conjoined in a single sensor assembly as further discussed below. In such cases, the data captured by the pressure sensor and position sensor unit 101 are combined to accurately estimate the position of the valve 102. Such configurations provide at least two data points that improve the accuracy of estimating the position of the valve 102 as further discussed below.

Additionally, the position sensor unit 101 may include electronics that enable wireless or wired communications with external monitoring devices such as computing systems. This advantageously allows: downstream monitoring of the valve position (i.e., the position of the valve plug 103); confirming whether the valve 102 is open or closed based on the position of the valve plug 103; determining whether the open or closed states of the valve 102 is as expected in accordance with expected settings determined by a well operator; etc.

Prior art systems have typically used visual inspection of the position of the actuator rod 104 (or some other on-site mechanical indicator) to determine the valve position. Other prior art systems have used resistive-based position sensors with actuator rods that can also determine the position of the pneumatically controlled diaphragm 106. However, such systems are not as robust and reliable as the pneumatic actuator and wellhead valve assembly 100 constructed using the position sensor unit 101 approach described in the present embodiments. In particular, an optical-time-of-flight sensor associated with the position sensor unit 101 unit can optically detect the relative position (e.g., vertical position) of the pneumatically controlled diaphragm 106, and accordingly the state of the valve 102, without the need for any visual on-site inspection.

In some prior art implementations, the valve position can be determined using a magnetic-based sensor that applies the Hall effect to address the mechanical and structural problems endemic to the resistive-based solutions. When implemented, magnetic-based sensors for valve position determination can be affected by the ambient magnetic response of the surrounding area in which they are located. For example, moving or changing the positions of metallic structures or objects around the magnetic-based sensor can significantly affect the reliable operation of the magnetic-based sensor. Unlike the magnetic-based sensor, the presently disclosed position sensor unit 101 is not only reliable but is also unaffected by its surroundings.

Another prior art solution uses a linear variable differential transformer (LVDT) to determine the valve position Like the magnetic-based sensor, the LVDT also addresses reliability issues associated with the resistive-based position sensors. However, the LVDT solutions are generally exorbitantly priced and often require power-hungry electronic components that are driven by alternating current (AC) power. Unlike the LVDT solutions for valve position determination, the electronics of the position sensor unit 101 are relatively cheap and can determine and communicate valve position data to external monitoring devices using very little electrical power.

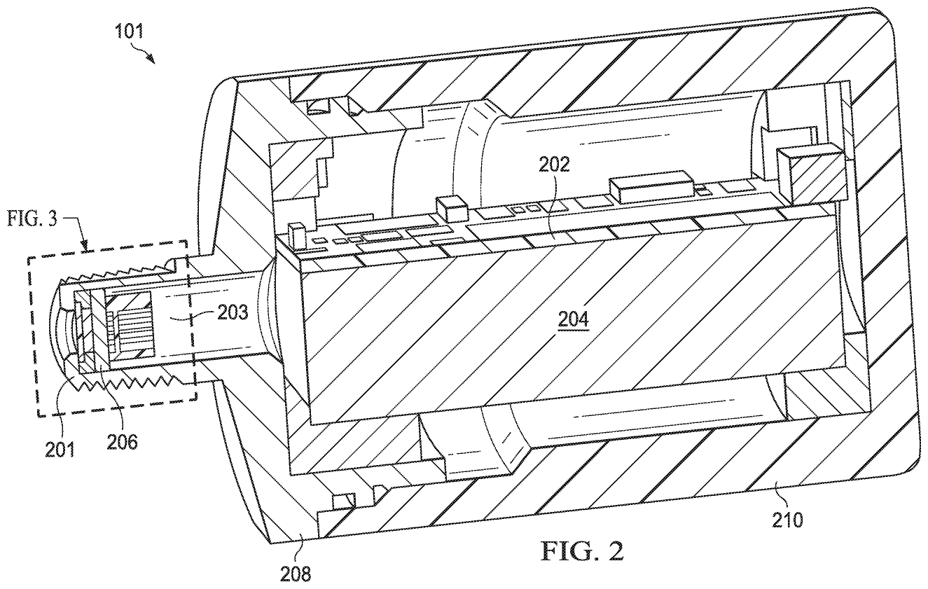

FIG. 2 is an example cross-sectional view of the position sensor unit 101 according to one embodiment of this disclosure. As seen in the figure, the position sensor unit 101 may include an electronic control unit 202, modular power 204, and an optical-time-of-flight sensor 206. The electronic control unit 202, the modular power 204, and the optical-time-of-flight sensor 206 may be housed in a housing that shields and protects the internal components of the position sensor unit 101 from environmental conditions. In one embodiment, the housing comprises a metallic casing 208 that is made of stainless steel or some other weather-resistant metal. In other embodiments, the housing comprises a cap 210 that is fabricated, for example, using plastic or some other non-metallic weather resistant material. In some instances, the housing includes a combination of the metallic casing 208 and the cap 210 consistent with principles disclosed in this specification. For example, the cap 210 may be an ultraviolet (UV) resistant non-metallic casing that screws onto the metallic casing 208 to form the housing. Further, in order to ensure that the internal components of the position sensor unit 101 are protected from mechanical impacts and other environmental conditions that can adversely affect its operation, the various components within the housing of the position sensor unit 101 may be supported or otherwise secured using support structures and sealants as further discussed below.

Moreover, various connectors of similar and/or different configurations can connect the internal components of the position sensor unit 101 to each other and to external circuitry depending on the implementation. In one embodiment, the connectors communicatively coupling the internal components of the position sensor unit 101 comprise an inter-integrated circuit (I²C) serial bus cable. In another implementation, the connectors include a 4 conductor 1 mm pitch flat-flex cable and/or a 4 conductor 0.5 mm flat flex cable. In other embodiments, the connectors include combinations of I²C cables, 4 conductor 1 mm flat flex cables, and/or 4 conductor 0.5 mm flat flex cable. In some further instances, other flat flex cable types, hardwired connectors, other bus types, and/or other connector methodology may be used to communicatively couple the electronic components within the housing of the position sensor unit 101.

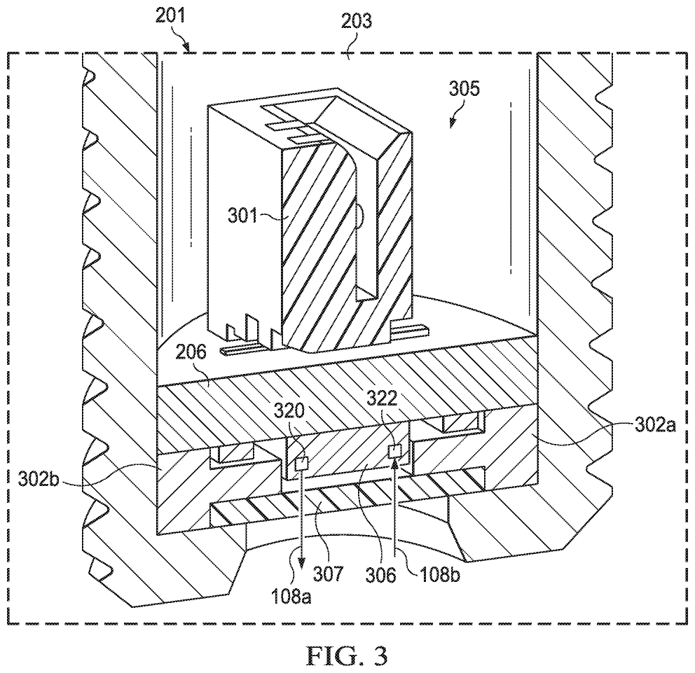

The optical-time-of-flight sensor 206 of the position sensor unit 101 may be configured for use with a diaphragm 106 associated with a valve 102, although it can also be used with different diaphragm types associated with different valve types. In the case of a pneumatically controlled diaphragm 106 (see FIG. 1A), the position sensor unit 101 may comprise a port 201 that houses the optical-time-of-flight sensor 206 and an optically transmissive seal for allowing light 108a to be transmitted from a light source 320 (see FIG. 3) of the optical-time-of-flight sensor 206 to the diaphragm 106 (see FIG. 1B) and to further allow reflected light 108b from the diaphragm 106 to be transmitted back to an optical detector 322 (see FIG. 3) comprised in the optical-time-of-flight sensor 206. As seen in FIG. 2, the port 201 is an optical port that forms part of the housing of the position sensor unit 101 and comprises a port cavity 203 into which is fitted the optical-time-of-flight sensor 206 along with other components of the position sensor unit 101. As seen more clearly in the zoomed-in cross-sectional view of the port 201 in FIG. 3, the port cavity 203 may house the optical-time-of-flight sensor 206 communicatively attached to the cable connector 301 on one side. The cable connector 301 may communicatively couple the optical-time-of-flight sensor 206 to other components of the position sensor unit 101 via a connector such as those discussed above. For example, the cable connector 301 can connect the optical-time-of-flight sensor 206 to the electronic control unit 202 (see FIG. 2) via a data bus/cable so that measurements captured by the optical-time-of-flight sensor 206 can be transmitted to the electronic control unit via the data bus. The electronic control unit 202 is operable to control various components of the position sensor unit 101 and is configured to communicate with other devices or systems external to the position sensor unit 101. For instance, the electronic control unit can receive monitoring signals (e.g., diaphragm displacement measurements) from the optical-time-of-flight sensor 206 via the data bus attached to the cable connector 301 and to the electronic control unit 202. The received monitoring signals can be transmitted by, for example, a wireless transceiver associated with the electronic control unit 202 to an external analytics device for further analysis. These aspects are further discussed below.

Seen at the other side of the optical-time-of-flight sensor 206 in FIG. 3 is an optical unit 306 comprised in the optical-time-of-flight sensor 206. The light source 320 and optical detector 322 of the optical unit 306 transmits and receives light (e.g., one or more optic pulses or photons) 108a, 108b via the optically transmissive seal 307 respectively to and from the pneumatically controlled diaphragm 106 of FIG. 1B. It is appreciated that although the light transmission is described in this embodiment as coming from a light source 320 such as a laser diode, other types of light transmission technologies may be used. Further, the optical detector 322 may be a charge-coupled device (CCD) sensor, other technologies may be used in this or other embodiments without departing from the scope of the embodiments disclosed in this specification or the spirit of any claims that may issue from this application.

The optically transmissive seal 307 may comprise a glass lens or some other suitable material with a light transmissivity suited to the functions of the optically transmissive seal 307. It should be appreciated that although the optical glass lens is described as a “lens,” the optically transmissive seal 307 may be a flat glass piece without optical power. Further, so long as the material used to fabricate the optically transmissive seal 307 has a suitable light transmissivity and other material characteristics such as mechanical strength, durability, sealing capacity, appropriate melting temperature, and other material science characteristics, it may be of a material other than glass.

To hold in place the various components within the port cavity 203 of the port 201, a number of securing methodologies may be used. For instance, the optical-time-of-flight sensor 206 may be mounted on one or more support structures 302a and 302b that are bonded to the optically transmissive seal 307 to secure the optical-time-of-flight sensor 206 in place and to allow other components within the port cavity 203 to be accordingly positioned around the optical-time-of-flight sensor 206. In one implementation, the support structures may be made of insulator materials such as polyvinyl chloride, glass, asbestos, rigid laminate, Teflon, fiberglass and rubber.

Moreover, the port volume 305 surrounding the cable connector 301 may be filled with a sealant that minimizes the likelihood of ambient gases coming into contact with the electronics within the housing of the of the position sensor unit 101 through the port 201. This is because without this protection, intrusion gases from fluid or gas in an oil or gas pipeline to which the position sensor unit 101 is coupled, or other environmental gases or moisture, could otherwise bypass the optical-time-of-flight sensor 206 and the port volume 305 before coming into contact with other energized electronic circuitry such as the electronic control unit 202 within the housing of the position sensor unit 101. As such, applying a sealant to the port volume 305 can greatly minimize or prevent this “in-gassing.” Moreover, the sealant also prevents outgassing and/or sparking from within the housing of the position sensor unit 101 in the event of an electrical malfunction such as a blown fuse, a shorted circuit element, or an electronic failure of one or more components within the housing of the position sensor unit 101. In some cases, the sealant helps to fix in place the various internal components of the position sensor unit 101 such as the optical-time-of-flight sensor 206 and the cable connector 301. The sealant can be an epoxy-based material and/or a silicone-based material. In some implementations, the sealant is a urethane-modified epoxy material and/or a polysulfide-modified epoxy material. It should appreciated that the optically transmissive seal 307 and the support structures 302a and 302b, when used in combination with the sealant improve the robustness and the structural/material integrity of the position sensor unit 101.

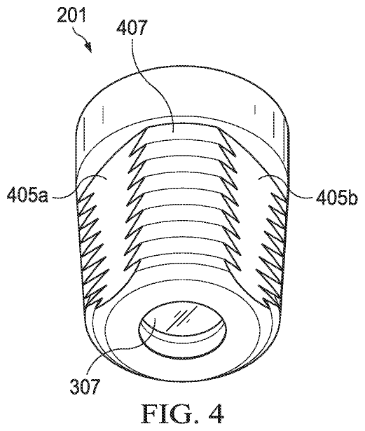

Further, the port 201 may be configured with a threaded coupling to allow the position sensor unit 101 to be mounted on the actuator 105. More specifically, the port 201 may include a threading 407 such as those shown in FIG. 4. In one embodiment, the threading allows the position sensor unit 101 to be fastened to the actuator 105 within which is captured the pneumatically controlled diaphragm 106. The threading 407 may have one or more flats 405a and 405b cut into its structure that avoid a pressure/vacuum that would hamper diaphragm 106 expansion or contraction. This can also beneficially prevent structural and/or mechanical failures or degradation of one or more of the support structures and/or sealants discussed above due to pressure buildup within the housing of the position sensor unit 101. Thus, in embodiments where flats 405a and 405b are used, it prevents pressure from building up within the chamber 111a.

The optical-time-of-flight sensor 206 within the port 201 may be operable to estimate or calculate distance from the optical unit 306 to the diaphragm 106 based on transmitted and reflected light pulses 108a, 108b and thereby measure the diaphragm displacement. More specifically, the optical unit 306 includes a light source 320 that generates one or more optical pulses 108a and an optical detector 322 that detects one or more reflected optical pulses 108b. The light source 320 transmits the generated one or more optical pulses 108a to the diaphragm 106. The transmitted one or more optical pulses 108a are then partially reflected on the diaphragm 106 and return back as reflected optical pulses 108b to the optical unit 306, where they are detected by the optical detector 322 associated with the optical unit 306. The optical-time-of-flight sensor 206 then determines the time it took for optical pulses to travel from the light source 320 to the diaphragm 106 and back to the optical detector 322. This time may be referred to as a round-trip propagation time. The round-trip propagation time can be translated into a distance indicative of the diaphragm displacement. In one implementation, the distance by which the diaphragm is displaced is given by:

Distance=½×round−trip propagation time×c,

where c is the speed of light.

In some implementations, the optical-time-of-flight sensor 206 determines this distance, alone or in coordination with the electronic control unit 202. In other implementations, the optical-time-of-flight sensor 206 and/or the electronic control unit 202 include filters, samplers, or other signal processing logic or circuitry that aid in the calculation of the distance by which the pneumatically controlled diaphragm 106 is displaced. For example, the filters, samplers, or other signal processing logic or circuitry can improve the resolution of the optical-time-of-flight sensor 206. Resolution as used here refers to the smallest change in time it takes the light detector in the optical unit 306 to detect reflected light pulses. Additionally, the filters, samplers, or other signal processing logic or circuitry can remove noise from measurements captured by the optical-time-of-flight sensor 206 and/or other sensors coupled to the position sensor unit 101.

While the position sensor unit 101 has been described in the context of being housed by itself within the port 201, the principles described in this disclosure are also applicable to configurations where the housing of the position sensor unit 101 includes other sensors such as a pressure sensor, a vibration sensor, or some other sensor in combination with the optical-time-of-flight sensor 206. For example, the overall position sensor unit 101 assembly may include a pressure sensor (not shown) either directly integrated into its design or communicatively coupled to the position sensor unit 101. In such implementations, the position sensor unit 101 may be mounted on the lower side 110b (see FIG. 1B) so that dual measurements of diaphragm displacement and pressure within the pressurized chamber 111b can be respectively captured by the optical-time-of-flight sensor 206 and the pressure sensor. These measurements can be used in combination to more accurately determine both the diaphragm displacement and pressure in connection with each other and within a single assembly. The position sensor unit 101 can also be mounted on top of the unpressurized chamber 111a (see FIG. 1B) while the pressure sensor is mounted at the bottom of the pressurized chamber 111b. This may be accomplished using an external adapter compatible with the optical-time-of-flight sensor 206 and/or an external adapter compatible with the pressure sensor to respectively couple the optical-time-of-flight sensor 206 and/or the pressure sensor to the position sensor unit 101 and to appropriate locations on the actuator 105 of FIG. 1B.

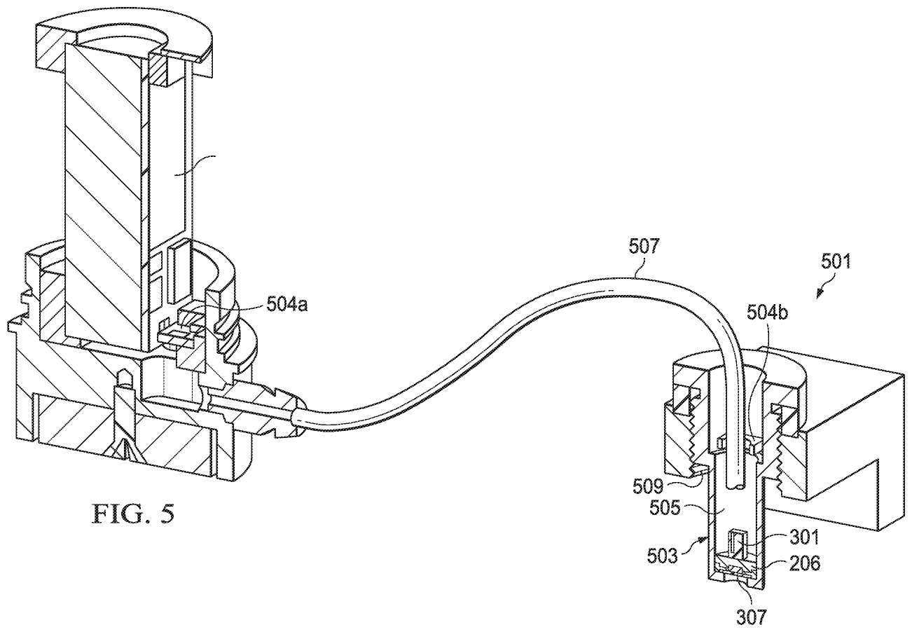

In implementations where the position sensor unit 101 is adapter-enabled, the optical-time-of-flight sensor 206 may be fitted to an external adapter 501 and communicatively coupled to the position sensor unit 101 via a cable 507 as shown in FIG. 5. Such implementations modify the position sensor unit 101 with the following changes: a) the external adapter 501 acts like the port 201; b) adapter boards 504a and 504b may be respectively fitted to the position sensor unit 101 and to the external adapter 501; and c) the adapter boards 504a and 504b are coupled to each other using the cable 507. The cable 507 can be any suitable length depending on the application. For example, the cable may be about 24 inches, 20 inches, 15 inches, or 10 inches. It is noted that the external adapter 501 may be smaller in size relative to the position sensor unit 101.

The embodiment of FIG. 5 facilitates in some embodiments the retrofitting of the optical-time-of-flight sensor 206 to pneumatic actuator and wellhead valve assemblies, and is particularly suited to valve and actuator applications having space constraints that restrict fitting the position sensor unit 101 directly to existing threading-receptacles on actuators 105 associated with pneumatic wellhead and valve assemblies. Moreover, the above changes can also be applied in embodiments involving multiple sense elements other than the optical-time-of-flight sensor 206 in order to couple multiple different sensors to the pneumatic actuator and wellhead valve assembly 100. Such multiple different sensors can also, however, be similarly coupled through Wi-Fi or other RF communication measures using embedded circuitry in their respective control units as was described in this specification with regard to the embodiment of FIG. 2.

As seen in FIG. 5, the external adapter 501 may have an adapter cavity 503 which houses the optical-time-of-flight sensor 206 with its optical unit 306, as well as the optically transmissive seal 307. The external adapter 501 may also contain an adapter board 504b which transitions signals captured by the optical-time-of-flight sensor 206 to the cable 507. The adapter volume 505 may be sealed using the sealing methodology of the port volume 305 described with reference to FIG. 3. Additionally, the external adapter 501 may have threading 509 configured for coupling the optical-time-of-flight sensor 206 to the actuator 105.

It should be appreciated that the optical-time-of-flight sensor 206 described in this application can detect the current position of the valve plug 103 relative to a zero-point position based on the diaphragm displacement as previously noted. Additionally, positions such as a closed valve position and an open valve position can change due to wear and tear of the valve plug 103. For example, if a closed position of a new valve plug 103 is at a 0% position, over time the closed position may change to −1%, −3%, or −5%, which depending on design constraints may indicate that the valve plug 103 should be shut further with respect to the original closed position due to the wear on the internal valve components and can also indicate an ultimately impending failure condition that could be proactively avoided. The disclosed optical-time-of-flight sensor 206 may be directly correlated with the pressure in the pressurized chamber 111b through their respective measurements to make such adaptive determinations. For example, the embodiment shown in FIG. 1B indicates that as the pressure in the pressurized chamber 111b increases, the position sensor measurements decreases. This is because the increase in pressure at the pressurized chamber 111b causes the pneumatically controlled diaphragm 106 to be displaced toward the optical-time-of-flight sensor 206 effectively reducing the distance between the optical-time-of-flight sensor 206 and the pneumatically controlled diaphragm 106. However, if the optical-time-of-flight sensor 206 is mounted on the lower portion 110b of the actuator directly opposite the pneumatically controlled diaphragm 106, the diaphragm displacements captured by the optical-time-of-flight sensor 206 would be directly proportional to the pressure increases within the pressurized chamber 111b. Consequently, at any time of operation, and depending on the given embodiment, a predefined ratio may be established between measurements associated with the diaphragm displacement captured by the optical-time-of-flight sensor 206 and the pressure within the pressurized chamber 111b. For example, the predefined ratio may be given by:

postion sensor measurement (psm):pressure measurement (pm).

A determination of the psm:pm ratio can be used to automatically reconfigure the pneumatic actuator and wellhead valve assembly 100 even when the valve 102 ages. For example, given the embodiment of FIG. 1B, the psm:pm may initially be 1:1 for a new pneumatic actuator and wellhead valve assembly 100. However, as the valve 102 ages (e.g., after 5 years), the psm:pm may become 1:1.02 because more pressure would be required to close the valve plug 103 due to the wear on the valve 102. Accordingly, the pressure would have to be increased by a factor of 2 percent, for example, in the pressurized chamber in order to have the same closing effect on the aged valve 102 as the closing effect on a new valve 102. Other example predefined psm:pm ratios include 1:1.3, 1:1.4, and 1:1.7 depending on factors such as the age of the valve 102, and wear and tear experienced by internal mechanisms or components of the pneumatic actuator and wellhead valve assembly 100.

In some embodiments, the pm stays constant relative to the psm during the lifetime of the valve 102. In such cases, the psm can change over the course of time that the valve 102 is used based on the wear and tear experienced by the internal components (e.g., valve plug 103) of the valve 102. For such implementations, it is assumed that the constancy of the pm depends, at least, on seals and other pressure control mechanisms associated with the actuator 105 not degrading.

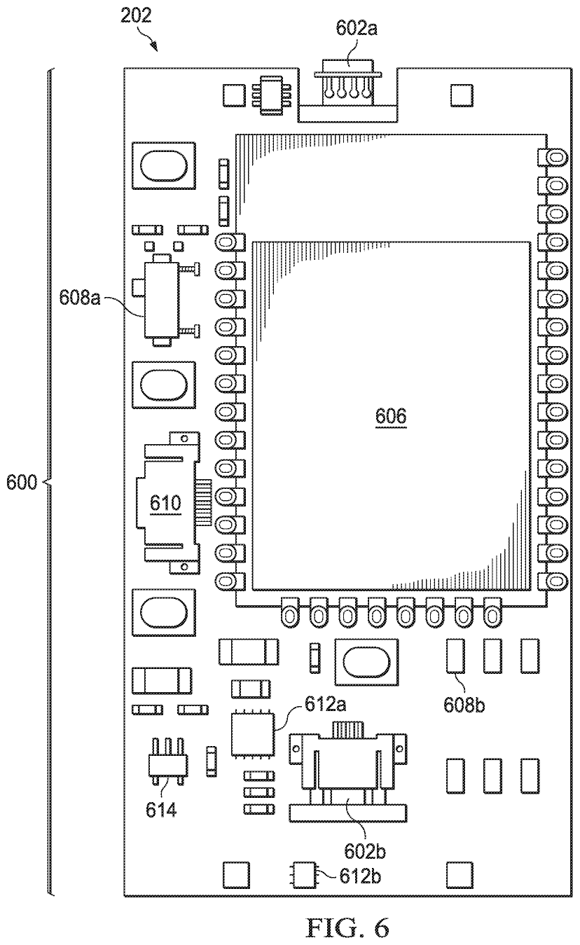

In either of the embodiments shown in FIG. 3 or 5, the optical-time-of-flight sensor 206 may be communicatively coupled to the electronic control unit 202 via a cable connected to the connector 301. The electronic control unit 202 may comprise a printed circuit board (PCB) 600 having a plurality of subcomponents such as connector pins 602a and 602b, a microcontroller 606, switches 608a and 608b, programming connectors 610, one or more integrated sensors 612a and 612b, and a voltage regulator 614 as illustrated in FIG. 6, for example. The electronic control unit 202 is in electrical communication with the optical-time-of-flight sensor 206 and can control the optical-time-of-flight sensor 206 and other sensors or subunits associated with the position sensor unit 101. In some implementations, the electronic control unit 202 also provides detected measurements captured by the optical-time-of-flight sensor 206 and/or other sensor(s) coupled to it to external monitoring devices or control systems.

The connector pins 602a and 602b can couple components of the position sensor unit 101 that are external to the PCB 600 to the PCB 600. For example, the connector pins 602a and 602b may be configured with pins to which a cable is attached to connect the PCB 600 to the optical-time-of-flight sensor 206. In one embodiment, the cable attached to the connector pins 602a and 602b is an I²C bus. In some implementations, the connector pins 602a and 602b provide data and clock lines to a cable such as the cable 507 of FIG. 5.

The microcontroller 606 may communicate with onboard components of the PCB 600 and with other components external to the PCB 600. In one embodiment, the microcontroller communicates with components associated with the position sensor unit 101 via hardwired and/or wired connections whiles communicating with devices external to the position sensor unit 101 via wired and/or wireless connectivity. For example, the microcontroller 606 has an integrated wireless transceiver with wireless connectivity for communicating with monitoring devices external to the position sensor unit 101. The microcontroller 606 may receive captured measurements by the optical-time-of-flight sensor 206 and wirelessly transmit the captured measurements via a radio link using the wireless transceiver to a gateway device external to the position sensor unit 101. The gateway device may relay the captured measurements to other monitoring devices that further process the captured measurements. In some implementations, the microcontroller can also receive instructions transmitted from external monitoring devices to the position sensor unit 101. For example, the microcontroller can receive instructions via the integrated wireless transceiver to activate an indicator coupled to the position sensor unit 101, or perform some other control action associated with the position sensor unit 101.

In some implementations, the microcontroller 606 is a Digi International XB24CZPISB003 microcontroller that includes an NXP MC9S08QE32 microcontroller, a 2.4 GHz radio, and an integrated antenna. Additionally, power to the microcontroller 606 may be supplied directly from the modular power 204 and/or from some other power source at a nominal voltage such as 2.8 V or 3.0 V. The one or more switches 608a and 608b on the PCB 600 may be communicatively coupled to the microcontroller 606 to enable modifying network parameters of the position sensor unit 101 during execution of initial setup configuration operations while programming connectors 610 allow a data cable to be coupled to the microcontroller during execution of the initial setup configuration operations.

Sensors 612a and 612b may be sensors integrated into the PCB 600 and function independently or in coordination with other sensors coupled to the position sensor unit 101. These sensors may include a vibration sensor, a pressure sensor, and a temperature sensor. Further, the voltage regulator 614 shown in FIG. 6 may be the supplier of regulated power for devices on the PCB 600 and to other devices external to the PCB 600 but associated with other electronic components of the position sensor unit 101.

Power to the electronic control unit 202 and to other electronic components of the position sensor unit 101 such as the optical-time-of-flight sensor 206 may be supplied by the modular power 204 (see FIG. 2), although other power sources such as grid-power, solar power, wind power, or combinations thereof can also serve as substitutes to the modular power 204 in other embodiments. Modular power 204 may, in some implementations comprises one or more batteries arranged in a series or parallel configuration. In one embodiment, the one or more batteries are AA sized primary lithium batteries having a nominal voltage of 2.8 V or 3.0 V. Additionally, the modular power 204 may have safety features designed to limit current in the event of a short circuit of a battery or an abnormal battery operation. For example, a fuse may be coupled to the modular power 204 to limit the current delivered to the electronic control unit 202 in a case of a short-circuit.

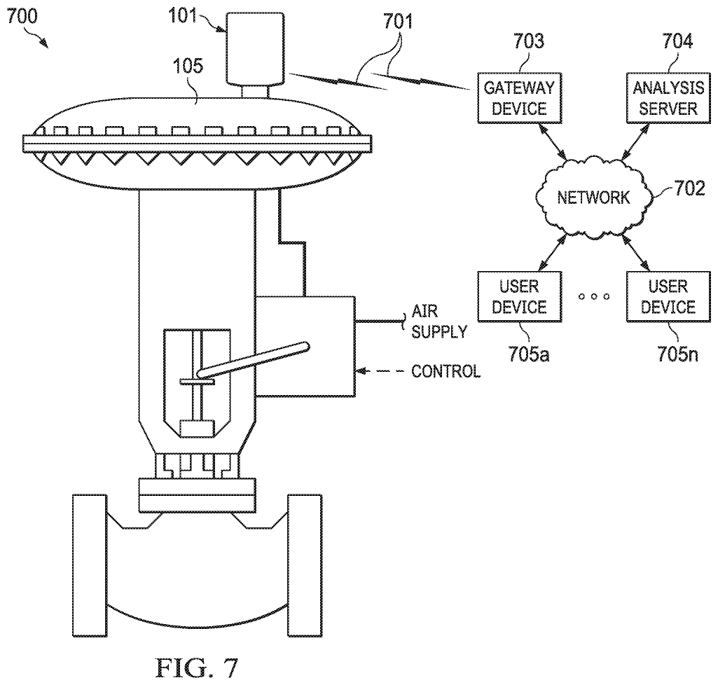

FIG. 7 shows a system 700 in which the position sensor unit 101 is communicatively coupled to other external devices. In one embodiment, the position sensor unit 101 is coupled to the upper portion of the actuator 105 and wirelessly transmits and receives data via the wireless link 701 to gateway device 703. For example, the position sensor unit 101 may transmit captured data associated with diaphragm displacement to the gateway device 703 which then sends this captured data to an analysis server 704 and to one or more user devices 705. In the illustrated embodiment, the transmission of data from the position sensor unit 101 to the gateway device 703 is via a wireless link 701. However, the position sensor unit 101 may be configured to transmit and receive information from the gateway device 703 via other links such as a local area network line, a fiber optics line, or some other form of wired connectivity between the gateway device 703 and the position sensor unit 101.

The gateway device 703 may be separate from the position sensor unit 101 and can be configured to relay received data to other devices within the system 700. For instance, the gateway device 703 may receive measured diaphragm displacement from the position sensor unit 101 following which it sends this information to devices such as the analysis server 704 and/or the one or more user devices 705. In some instances, the gateway device 703 can also send instructions or other information from devices like the user device 705 and/or the analysis server 704 to the position sensor unit 101. In one embodiment, the gateway device 703 packages received data or instructions before relaying them to appropriate devices within the system 700. In other embodiments, the gateway device filters received data before forwarding the received data to other devices within the system 700. Thus, the gateway device 703 can be thought of as a “gate” to and from the position sensor unit 101. In some implementations, the gateway device 703 is a router, a firewall server, or some other device that enables traffic flow to and from the position sensor unit 101.

The network 702 coupling the various devices in the system 700 may include a plurality of networks. For instance, the network 702 may include any wired/wireless communication link and in some instances, includes an Ethernet network, a cellular network, a computer network, the Internet, a Wi-Fi network, a light fidelity (Li-Fi) network, a Bluetooth network, a radio frequency identification (RFID) network, a near-field communication (NFC) network, a laser-based network, or other types of networks according to design needs.

The analysis server 704 can analyze data captured by the position sensor unit 101. The analysis server 704 can also send one or more instructions or results to other devices within the network 702. In one embodiment, the analysis server is equipped with tools and processing functionality that enable it to run analytics on data received from the position sensor unit 101. In some instances, the analysis server 704 operates as a cloud-based computing resource in the system 700. In such a case, the analysis server 704 functions as a remote network server hosted on the internet to store, manage or otherwise process data received from the position sensor unit 101 and/or other devices associated with the system 700.

Remotely processing or analyzing data away from the position sensor unit 101 has a number of benefits. For instance, doing this negates the need to directly couple bulky and usually expensive computing resources to the pneumatic actuator and wellhead valve assembly 100 which may be impracticable in some instances. Rather, low power consuming devices such as the position sensor unit 101 can be used to capture monitoring signals such as diaphragm displacement using the optical-time-of-flight sensor 206. The analysis server can also facilitate off-site monitoring of the pneumatic actuator and wellhead valve assembly 100 via the position sensor unit 101. In some embodiments, the analysis server 704 can execute analytics on monitoring signals from the position sensor unit 101 to detect certain statistical trends regarding operating states of the valve 102. In some instances, the analysis server 704 can also simultaneously transmit results from processing or analyzing of monitoring signals from the position sensor unit 101 to stakeholders such as valve operators, technicians, site administrators, and project managers at different locations via the one or more user devices 705a . . . 705n.

Analyzing monitoring signals transmitted from the position sensor unit 101 by the analysis server 704 can also include comparing the monitoring signals from sensors such as the optical-time-of-flight sensor 206 to baseline measurements to determine an operating state associated with the valve 102 of FIG. 1. The operating state associated with the valve 102 may indicate whether the valve 102 is operating as configured or whether the valve 102 is malfunctioning. For instance, the position sensor unit 101 may capture distance associated with the displacement of the pneumatically controlled diaphragm 106 using the optical-time-of-flight sensor 206. This captured distance may be controllably transmitted by the microcontroller 606 via the wireless link 701 as discussed above. Responsive to receiving the captured distance from the gateway device 703 via the network 702, the analysis server 704 may execute analytics on the received captured distance. In one embodiment, this includes correlating the captured distance to previously captured distances associated with the pneumatically controlled diaphragm 106 corresponding to valve positions. Based on this, the valve position can be determined as either open, closed, or partially closed.

In implementations where the monitoring signals include, for example, diaphragm displacement measurements captured by the optical-time-of-flight sensor 206, the monitoring signals can be used to determine the pressure within the pressurized chamber 111b of the actuator 105 (see FIG. 1B). In such cases, baseline measurements corresponding to previously captured diaphragm displacements with their associated pressures within the pressurized chamber 111b can be compared to the diaphragm displacement measurements included in the monitoring signals to determine the pressure within the pressurized chamber 111b.

As another example, the analysis server 704 can analyze the captured distance associated with the diaphragm displacement within the pneumatic actuator and wellhead valve assembly 100 by processing the captured distance received from the position sensor unit 101 in association with previously gathered valve data associated with the valve 102 to determine trends of operation and to also revise psm:pm ratio associated with the valve 102. As a further example, the analysis server 704 can digitally resolve the captured distance associated with the diaphragm displacement of the pneumatically controlled diaphragm 106 within the pneumatic actuator and wellhead valve assembly 100 to generate a more accurate measurement of the diaphragm displacement. Other example functions of the analysis server 704 include automatically adapting valve actuation mechanisms associated with the pneumatic actuator and wellhead valve assembly to accommodate aging of components associated with the pneumatic actuator and wellhead valve assembly 100 using for example, a revised psm:pm ratio.

In other implementations, the analysis server 704 can generate one or more alerts or some other instructions and transmit the one or more alerts and/or instructions to the position sensor unit 101 and/or to the one or more user devices 705a . . . 705n. For example, after processing a captured diaphragm displacement associated with the pneumatically controlled diaphragm 106, the analysis server 704 can transmit an alert indicative of a malfunction associated with the valve 102 to one or more user devices 705 to notify stakeholders of the situation. Additionally or optionally, the analysis server 704 can transmit one or more alerts or instructions to the position sensor unit 101, or to some other electronic device associated with the pneumatic actuator and wellhead valve assembly 100 to activate one or more indicators that indicate the malfunction associated with the valve 102. The one or more alerts/instructions may also trigger an alarm/notification at a user device 705 and/or activate one or more indicators directly coupled to the position sensor unit 101 or to the pneumatic actuator and wellhead valve assembly 100.

In some embodiments, the one or more indicators when activated facilitate readily identifying the valve 102. The one or more indicators may include visual indictors such as light emitting diodes (LEDs that provide visual indications of the malfunction associated with the valve 102, and/or auditory indicators such as speaker alarms that provide sound alerts when the valve 102 malfunctions.

Although described in the context of a pneumatically actuated valve, the principles discussed in this disclosure are applicable to determining valve positions of other valve types. For example, the position sensor unit 101 can be used to determine the valve positions of valves such as ball valves, butterfly valves, control valves, gate valves, globe valves, needle valves, pinch valves, inlet valves, wellhead motor valves, safety relief valves, back pressure valves, and dump valves.

Reference in the specification to “one implementation” or “an implementation” means that a particular feature, structure, or characteristic described in connection with the implementation is included in at least one implementation of the disclosure. The appearances of the phrase “in one implementation,” “in some implementations,” “in one embodiment,” or “in some embodiments” in various places in the specification are not necessarily all referring to the same implementation.

Finally, the above descriptions of the implementations of the present disclosure has been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof. Accordingly, the disclosure of the present disclosure is intended to be illustrative, but not limiting, of the scope of the present disclosure, which is set forth in the following claims.

What is claimed is:

1. A position sensor unit for use in a pneumatic actuator wellhead and valve assembly, the pneumatic actuator and wellhead valve assembly comprising an actuator capturing a pneumatically controlled diaphragm that drives an actuator rod, the actuator rod translating with a displacement of the pneumatically controlled diaphragm and operable to mechanically actuate a valve to controllably pass gases or liquids according to one of an opening and a closing of a valve plug associated with the valve, the position sensor unit comprising:
a sensor housing, the sensor housing comprising an optical port for:
allowing an optical pulse from within the sensor housing to be transmitted to the pneumatically controlled diaphragm, and
allowing the sensor housing to receive a reflected optical pulse from the pneumatically controlled diaphragm back into the sensor housing;
an optically transmissive seal engaged within the optical port, the optically transmissive seal operable to:
pass the optical pulse from within the sensor housing to be transmitted to the pneumatically controlled diaphragm, and
pass the reflected optical pulse from the pneumatically controlled diaphragm back into the sensor housing;
an optical time-of-flight sensor comprising a light source and a light detector, the optical time-of-flight sensor being operable to measure a distance to the pneumatically controlled diaphragm and thereby determine the displacement of the pneumatically controlled diaphragm, the light source comprised in the optical time-of-flight sensor being operable to send one or more optical pulses to the pneumatically controlled diaphragm, the light detector comprised in the optical time-of-flight sensor being operable to detect reflected optical pulses from the pneumatically controlled diaphragm, the optical-time-of-flight sensor being operable to measure a round-trip propagation time of the one or more optical pulses in order to determine the displacement of the pneumatically controlled diaphragm; and
an electronic control unit in electrical communication with the optical time-of-flight sensor, the electronic control unit operable to control the optical-time-of-flight sensor and to provide detected measurements to an external monitoring device.

2. The position sensor unit of claim 1, wherein the electronic control unit further comprises a wireless transceiver for wirelessly transmitting the detected measurements to the external monitoring device.

3. The position sensor unit of claim 1, wherein the optical port is configured within a threaded coupling to be mounted to the actuator capturing the pneumatically controlled diaphragm.

4. The position sensor unit of claim 1 further comprising a modular power supplying power to the optical time-of-flight sensor and to the electronic control unit.

5. The position sensor unit of claim 1, wherein the external monitoring device comprises a cloud-based computing resource that analyzes the detected measurements.

6. The position sensor unit of claim 5, wherein to analyze the detected measurements comprises comparing the detected measurements to baseline measurements in order to determine an operating state associated with the valve.

7. The position sensor unit of claim 6, wherein the operating state associated with the valve indicates that the valve is malfunctioning.

8. The position sensor unit of claim 1, wherein the position sensor unit is coupled to one or more indicators, the one or more indicators indicating at least an operating state of the valve based on an alert received by the position sensor unit from the external monitoring device.

9. The position sensor unit of claim 8, wherein the one or more indicators provide a visual indication of a malfunction associated with the valve.

10. The position sensor unit of claim 1, wherein the detected measurements determine a pressure within a pressurized chamber of the actuator.
